(19) United States
(12) Patent Application Publication
(10) Pub. No.: US 2023/0211389 A1
(43) Pub. Date: Jul. 6, 2023

(54) SAXOPHONE CLEANING DEVICE

(71) Applicant: Yoon Sick KIM, Goyang-si (KR)

(72) Inventor: Yoon Sick KIM, Goyang-si (KR)

(21) Appl. No.: 18/001,072

(22) PCT Filed: May 24, 2021
(86) PCT No.: PCT/KR2021/006434

§ 371 Date: Dec. 7, 2022

(30) Foreign Application Priority Data
Jul. 6, 2020 (KR) 20-2020-0002408

(51) Int. Cl. B08B 9/043; G10D 9/00

(52) U.S. Cl. CPC B08B 9/0436; G10D 9/00; B08B 2209/04; H01F 7/02

(57) ABSTRACT

The present invention relates to a saxophone cleaning device, and the objective of the present invention is to enable the inside of a musical instrument having conical and curved shapes to be easily and more effectively cleaned, thereby assisting in managing the cleanliness of a saxophone. The present invention, for implementing this, relates to a saxophone cleaning device comprising: a cleaning unit 10 for cleaning the inside of the saxophone 100; and a pulling unit 20 for pulling the cleaning unit 10, wherein the cleaning unit 10 has cleaning cloths 12, 13 and 14 made from an absorbent material provided on a first string 11 having a predetermined length, and has a magnet 15 connected to one end portion thereof, and the pulling unit 20 has a metal piece 24 connected to one end portion of a second string 21 having a predetermined length, so as to be attached by means of the magnetic force of the magnet 15, and has, on the other end portion thereof, a winding means 22 around which the second string 21 is wound.

### TECHNICAL FIELD

The present invention relates to a cleaning device inside a saxophone, which is one of woodwind musical instruments, and more particularly to a functional saxophone cleaning device that enables cleaning work inside the saxophone to be performed more safely and conveniently, thereby improving the management efficiency of a saxophone.

### BACKGROUND ART

Generally, a woodwind musical instrument is a musical instrument that blows air into a tube to produce sound, and a wind instrument made of wood is called a woodwind instrument, and a wind instrument made of metal is called a brass instrument. Today, however, even woodwind instruments are made mostly of metal.

The types of such wind instruments are extremely diverse, but typical wind instruments include, for example, flute, piccolo, oboe, English horn, clarinet, faggot, saxophone, and the like.

In particular, saxophone is a musical instrument which is made of copper (brass, bronze, etc.) or silver materials, wherein the main body has a structure in which a body, a bow, and a bell are combined, the body forms a conical shape that is narrow at the top and spreads out gradually while descending downwards, the bow tube has a bent shape and connects the body and the bell, the bell part is shaped like a circular trumpet and has a complex structure with many keys and parts attached, and is heavy, so it requires careful management.

Meanwhile, due to the characteristics that the player breathes in to play, the player's saliva or foreign matters (coffee, chocolate, sugar content . . . ) in the mouth flow into the inside of the saxophone and are absorbed, and when warm breath enters the inside of the saxophone, condensation phenomena occur due to the temperature difference between the inside and outside, and thus, water drops are created inside the saxophone, especially, a considerable amount of moisture accumulates on the bow.

Therefore, after playing, it is necessary to cleanly remove saliva, foreign matters, moisture and the like accumulated inside the saxophone. Otherwise, bad odors, mold or rust may occur inside the saxophone.

In particular, a pad (leather stoppers covering the air holes), which is a major component, can be hardened to shorten its lifespan.

Thus, the saxophone is a musical instrument that requires careful management, while it is structurally not easy to clean the inside, and cleaning devices currently being used are generally made into two types.

One type thereof is to use a cleaning rod, that is, a method in which a long rod-shaped cleaning rod with cleaning hairs is pushed inside a saxophone body from the upside, and then the inside of the saxophone is cleaned while repeating forward and backward movements.

However, due to the structure of the saxophone, the entrance into which the cleaning rod can be inserted is narrow, and cleaning rods with a certain volume or more cannot be inserted. Thus, there was an inconvenience that it is difficult to clean the middle portion where the body spreads and the curvilinear bow where a large amount of water is accumulated.

Another type is a method of using a cleaning cloth having a weight (metal) attached to the end of the string, that is, a method in which the weight is inserted into the saxophone through the bell side, the saxophone is turned upside down so that the weight comes out toward the top entrance side of the main body, then the saxophone is returned to its original position (upright position), and then the string attached to the weight is pulled, and the cleaning cloth attached to the string ascends upward to clean the inside.

Such a cleaning cloth includes those attaching a string on one side and those attaching a string on both sides. Those attaching a string only one side are methods in which when the string is pulled to the upper end of the main body, the cleaning cloth attached to the string ascends to proceed the inside cleaning, and the string is continuously pulled so that the cleaning cloth is withdrawn outside the upper end. Those attaching a string on both sides aims at making the cleaning cloth reciprocate inside the tube body by holding both side strings, or are intended to be easily pulled out to the wide bell side of the space because it is difficult to pull out the cleaning cloth toward the upper end of the narrow space when attempting to use a cleaning cloth with a large area. Basically, the effect or method of cleaning the inside is the same.

In addition, the shapes of cleaning cloths used for this purpose are diverse. For example, Korean Utility Model Registration No. 20-0471448 discloses that cleaning cloths have a plurality of circular shapes, and there are also square and other shapes.

However, since the above cleaning cloth with a weight attached to the string requires repeating the operation of turning the saxophone upside down and then returning it to its original position, every time cleaning is performed to get the weight out of the saxophone body, which causes various problems.

That is, this action deforms or detaches the keys and other parts attached to the saxophone, causing a failure, and deformation or damage is caused by impact with the floor or surrounding objects. If the water accumulated in the Bow flows toward the upper end and flows into the tone hole (sound hole), the condition of the pad deteriorates and rust occurs around the tone hole.

In addition, the cleaning cloth cannot be used in a state where the saxophone is placed on a stand (cradle), and the cleaning work is neglected due to the inconvenience of cleaning, which causes deterioration of the condition of the saxophone. A part that protrudes about 4 to 6 mm exists on the inside of the upper end of the saxophone (inside the octave tone hole located about 2 cm from the entrance), which causes a problem that the weight attached to the string of the cleaning cloth gets caught in this portion and cannot be easily pulled out.

### DETAILED DESCRIPTION OF THE INVENTION

### Technical Problem

The present invention has been proposed to solve the problems of the above-mentioned prior arts, and the object of the present invention is to provide an improved form of functional cleaning device that can safely and effectively clean the inside of a saxophone without the process of physically turning the saxophone upside down and returning it to its original position in order to take the weight out of the body when using a cleaning cloth.

### Technical Solution

In order to achieve the above object, according to the present invention, there is provided a saxophone cleaning device comprising: a cleaning unit for cleaning the inside of the saxophone; and a pulling unit for pulling the cleaning unit, wherein the cleaning unit has cleaning cloths made of an absorbent material provided on a first string having a predetermined length, and has a magnet connected to one end portion thereof, and the pulling unit has a metal piece connected to one end portion of a second string 21 having a predetermined length, so as to be attached by means of the magnetic force of the magnet, and has, on the other end portion thereof, a winding means around which the second string is wound.

Also, the cleaning cloths are characterized in that a first cleaning cloth made of a functional material for removing primary foreign matters and moisture inside the saxophone, a second cleaning cloth made of an absorbent material for removing secondary foreign matters and moisture inside the saxophone and a third cleaning cloth made of absorbent material for removing tertiary foreign matters and moisture are connected to a first string in a form spaced at a predetermined interval, wherein among them, the first cleaning cloth and the second cleaning cloth have a shape in which a plurality of wings protrude at regular intervals along the edge.

### Advantageous Effects

The saxophone cleaning device of the present invention solves problems that may occur in the process of cleaning the saxophone using cleaning cloths, and exhibits the effect of being able to perform the cleaning work more safely and efficiently.

In particular, a method of pulling a cleaning cloth string by magnetic force using a pulling unit at the normal position of the saxophone by maximumly utilizing the structural characteristics of the saxophone not only can simultaneously solve the problems caused by the inconvenient and unstable previous technology in which the saxophone is turned upside down and turned over again by a physical method to pull out the weight of the cleaning cloth, but also has the advantage in that a plurality of functional cleaning cloths, that is, a first cleaning cloth, a second cleaning cloth, and a third cleaning cloth for removing foreign matters and moisture, are provided to clean the inside of the saxophone, so that the cleaning work can be performed more efficiently and cleanly.

### BRIEF DESCRIPTION OF THE DRAWINGS

FIG. 1 is a perspective view of a cleaning device according to one embodiment of the present invention;

FIG. 2 is a side structural diagram of the cleaning device of the present invention.

FIG. 3 is a state diagram of the cleaning device of the present invention before inserting it into a saxophone.

FIG. 4 is a state diagram of the cleaning device of the present invention after inserting it into a saxophone.

FIGS. 5 and 6 are diagrams of the saxophone cleaning state using the cleaning device of the present invention.

FIG. 7 is a side structure diagram of a magnet according to another embodiment of the present invention.

FIG. 8 is a cross-sectional view taken along the line A-A of FIG. 7.

FIG. 9 is a planar perspective view of a cleaning cloth according to another embodiment of the present invention.

### DETAILED DESCRIPTION OF THE EMBODIMENTS

Hereinafter, specific embodiments of the present invention will be described in detail with reference to the accompanying drawings.

Embodiments of the present invention can be modified in various ways, and the scope of the present invention is not limited to the embodiments set forth herein.

This embodiments are provided so that the present invention can be more fully explained to those of average knowledge in the art.

Therefore, the shape of elements in the drawings may be exaggerated to emphasize clearer description. It should be noted that the same configuration in each drawing is sometimes illustrated with the same reference numerals. Detailed descriptions of well-known functions and configurations which is determined to obscure the subject matter of the present invention will be omitted.

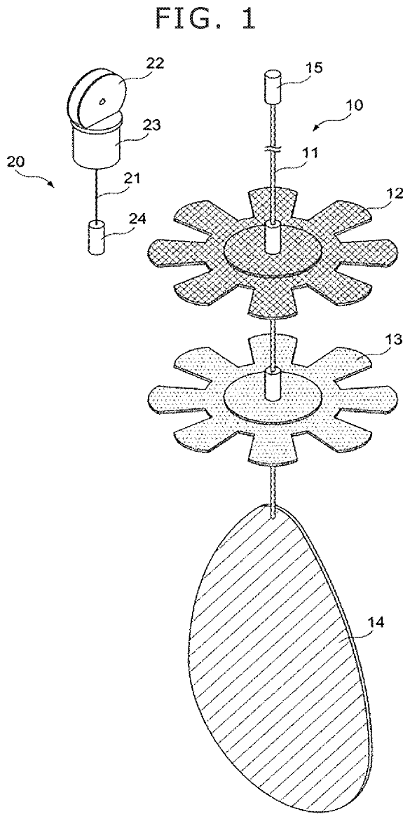

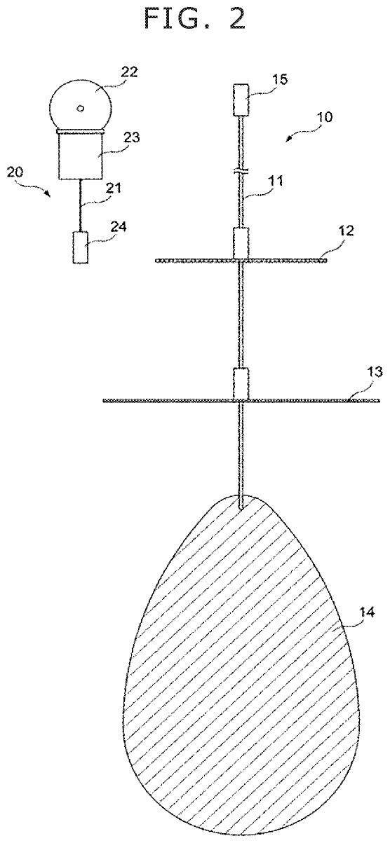

First, the configuration of the saxophone cleaning device according to one embodiment of the present invention will be described with reference to FIGS. 1 and 2.

A cleaning device according to the present embodiment includes a cleaning unit 10 for cleaning the inside of the saxophone 100, and a pulling unit 20 for pulling the cleaning unit 10.

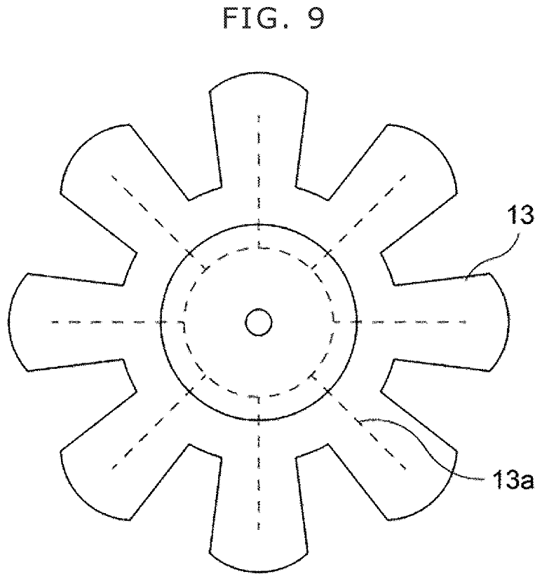

At this time, the cleaning unit 10 has cleaning cloths 12, 13 and 14 made of an absorbent material provided for removing foreign matters and moisture on a first string 11 having a predetermined length, and has a magnet 15 connected to one end portion thereof, wherein the cleaning cloths 12, 13 and 14 are configured such that a first cleaning cloth 12 made of a functional material for removing primary foreign matters and moisture inside the saxophone 100, a second cleaning cloth 13 and a third cleaning cloth 14 made of an absorbent material such as fluff or fabric for removing secondary foreign maters and moisture inside the saxophone 100, are connected to a first string 11 in a form spaced at a predetermined interval.

Wherein, it can be confirmed that the first cleaning cloth 12 and the second cleaning cloth 13 have a shape in which a large number of non-circular wings, for example, eight wings are provided to protrude along the edge at regular intervals as shown in FIG. 9, so as to make it easier to escape narrow spaces.

And, the pulling unit 20 has a metal piece 24 connected to one end portion of a second string 21 having a predetermined length, so as to be attached by means of the magnetic force of the magnet 15, and has, on the other end portion thereof, a winding means 22 around which the second string 21 is wound.

The winding means 22 in the present embodiment uses a mainspring having a certain elasticity inside, and has a structure in which a button is provided on one side. Wherein, the second string 21 is pulled out by being pulled by the user, and when a button is pressed, a pulling force acts and a pulling operation is performed.

Further, the cleaning cloths 12, 13 and 14 is made separable and attachable, so that they can be periodically separated from the first string 11 to perform easy cleaning and replace with another cleaning cloth.

An unexplained reference numeral 23 in the drawing indicates a support for supporting the winding means 22.

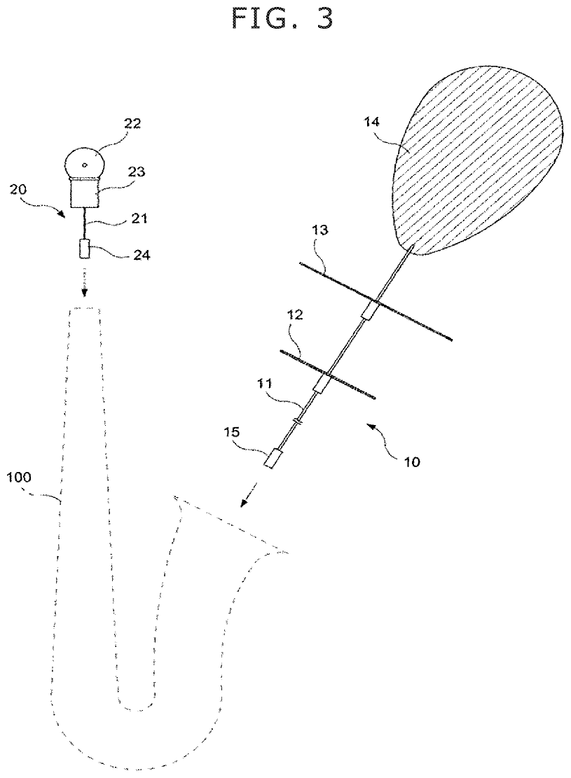

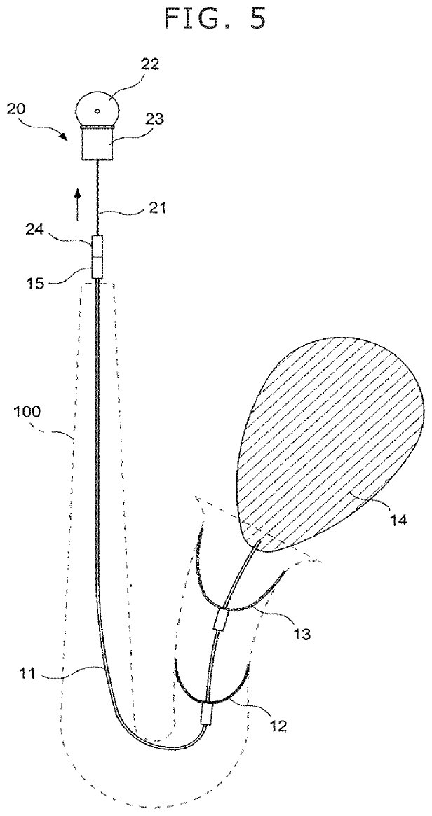

The action and effect due to the use of the cleaning device of the present invention having such a configuration will be reviewed with reference to FIGS. 3 to 6.

The cleaning device of the present invention is used when cleaning the inside of a saxophone, wherein the cleaning work is performed using the cleaning unit 10 and the pulling unit 20 which have a separable structure.

That is, as shown in FIG. 3, the cleaning unit 10 enters through a bell portion formed at the bottom of the saxophone 100 in a state where the saxophone 100 is erected, and the pulling unit 20 enters into the hole(tenon) where the upper neck of the saxophone 100 is separated. The magnet 15 and the metal piece 24 are connected by mutual magnetic force at the lower bow of a saxophone.

At this time, the magnet 15 having magnetic force is made to enter through the bell portion with a relatively wide aperture, so that it is possible to prevent an attachment phenomenon due to the metal parts inside the saxophone 100 and magnetic force.

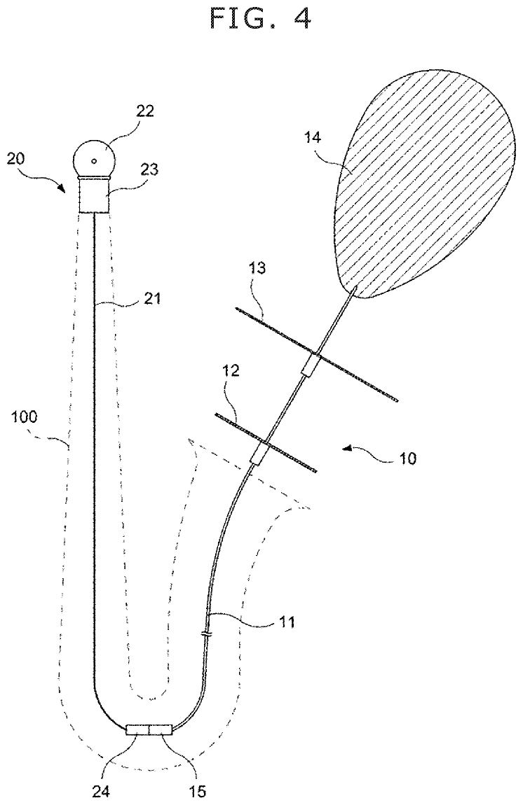

Meanwhile, in a state in which the cleaning unit 10 and the pulling unit 20 are connected by the magnet 15 and the metal piece 24 as shown in FIG. 4, if the button of the mainspring, which is the winding means 22 provided in the pulling unit 20, is pressed, the second string 21 is wound, and the first string 11 attached to the cleaning unit that has been attached by magnetic force is also pulled.

When the first string 11 is attached to the second string 21 and pulled upward in this way, the first string 11 is held by hand and pulled. At this time, the cleaning cloth attached to the first string 11 ascends from the bow side to the upper portion, so that foreign matters and moisture are removed by the first cleaning cloth 12. After that, foreign matters and moisture from the inner bow and the wall surface of the main body of the saxophone 100 are effectively removed by the second cleaning cloth 13 and the third cleaning cloth 14, which are absorbent materials.

In particular, the third cleaning cloth 14 can effectively remove a large amount of moisture accumulated on the bottom while sweeping up the bottom of the bow.

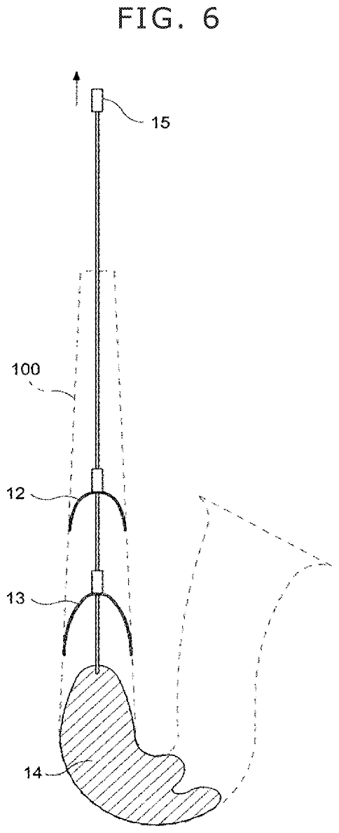

After that, as continuous pulling operation is performed, the first cleaning cloth 12 and the second and third cleaning cloths 13, 14 move upward along the inner wall surface of the saxophone 100 as shown in FIG. 6, so that foreign matters removal and water removal work are performed as a whole. After that, the cleaning cloth is discharged to the upper part to complete the cleaning operation.

Therefore, the saxophone cleaning device of the present invention not only solves various problems caused by the conventional technology of turning the saxophone upside down, removing the weight, and returning it to its original position, and pulling a cleaning cloth string, but also can effectively remove foreign matters and a large amount of moisture generated inside the saxophone, whereby the complicated cleaning work inside the saxophone, which has a conical and curved shape, can be performed easily and more effectively, which is able to give help in the cleanliness management of the saxophone.

In particular, the inside cleaning can be performed by a pulling method using magnetic force by maximumly utilizing the structural characteristics of the saxophone, and three types of functional cleaning cloths for removing foreign matters and absorbing moisture are provided, thus showing the advantage that internal cleaning work can be performed more efficiently.

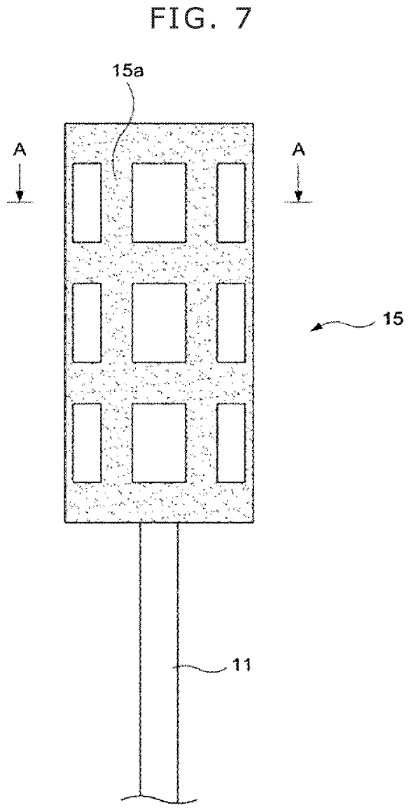

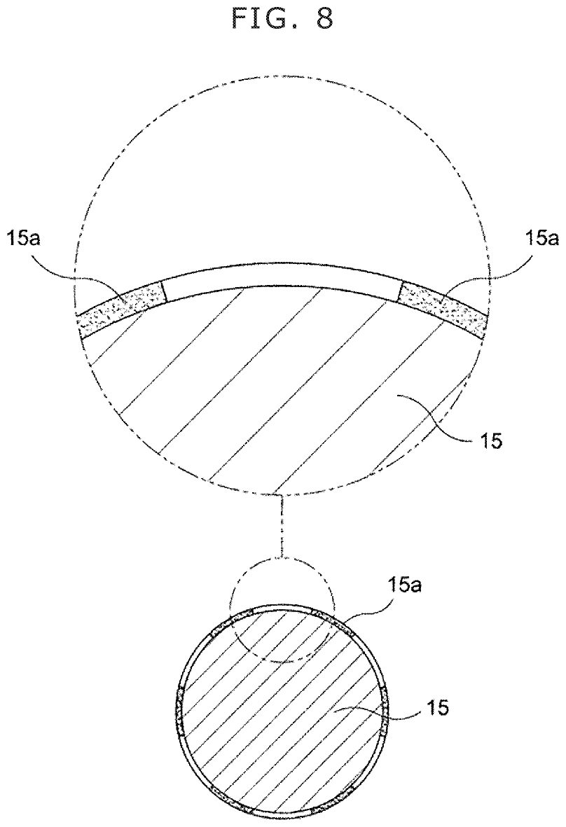

Meanwhile, FIGS. 7 and 8 show a configuration according to another embodiment of the present invention, in which a protective layer 15a for preventing damage due to friction with the inner wall surface of the saxophone 100 is coated and formed in a lattice shape on the surface of the magnet 15.

In particular, the protective layer 15a is preferably covered with a relatively soft material than the saxophone 100, such as soft material such as PVC, rubber or aluminum, in order to reduce a friction force.

Such a configuration of the protective layer 15a has an advantage in that impact and damage caused by friction with the inner wall surface of the saxophone 100 can be prevented in the process of inserting the magnet 15.

In particular, the protective layer 15a has the advantage that coupling with the metal piece 24 of the pulling unit 20 can be made smoothly in a desired direction by exposing only the portion that requires the magnetic force of the magnet.

FIG. 9 shows a configuration according to another embodiment of the present invention, wherein, for example, an elastic material 13a of a shape memory material or an elastic material having high resilience, such as a shape memory alloy or elastic sponge is provided in a radial form in the inside of the first and second cleaning cloths 12, 13, so as to be in close contact with the inner wall surface of the saxophone 100.

When such a configuration is achieved, a force acts in the direction in which the second cleaning cloth 13 spreads by the elastic support action of the elastic material 13a, so that a more stable contact state with the inner wall surface of the saxophone 100 can be maintained.

Therefore, there is an advantage that a uniform adhesion state is achieved as a whole, and thus the effect of removing moisture by the second cleaning cloth 13 is maximized.

And, although specific embodiments of the present invention have been described and illustrated above, it will be obvious that the saxophone cleaning device structure of the present invention can be variously modified and implemented by those skilled in the art.

For example, in the above-mentioned embodiment, the form in which the mainspring is used as the winding means for pulling the second string has been described and illustrated, but in addition to the mainspring, various types of winding means such as a manual pulley (string, foldable antenna, metal weight attached to a rod) can be applied.

Therefore, such modified embodiments should not be individually understood from the spirit or scope of the present invention, and such modified embodiments should be included within the scope of the appended claims of the present invention.

[Description of Reference Numerals]

| | |
|---|---|
| 10: cleaning unit | 11: first string |
| 12: first cleaning cloth | 13: second cleaning cloth |
| 14: third cleaning cloth | 15: magnet |
| 20: pulling unit | 21: second string |
| 22: winding means (mainspring) | 23: support |
| 24: metal piece | 100: saxophone |

1. A saxophone cleaning device comprising:
a cleaning unit 10 for cleaning the inside of the saxophone 100; and
a pulling unit 20 for pulling the cleaning unit 10,
wherein the cleaning unit 10 has cleaning cloths 12, 13 and 14 made of an absorbent material provided on a first string 11 having a predetermined length, and has a magnet 15 connected to one end portion thereof, and the pulling unit 20 has a metal piece 24 connected to one end portion of a second string 21 having a predetermined length, so as to be attached by means of the magnetic force of the magnet 15, and has, on the other end portion thereof, a winding means 22 around which the second string 21 is wound.

2. The saxophone cleaning device according to claim 1, wherein:
the cleaning cloths 12, 13 and 14 are configured such that a first cleaning cloth 12 made of a functional material for removing primary foreign matters and moisture inside the saxophone 100, a second cleaning cloth 13 made of an absorbent material for removing secondary foreign matters and moisture inside the saxophone 100 and a third cleaning cloth 14 made of absorbent material for removing tertiary foreign matters and moisture are connected to a first string 11 in a form spaced at a predetermined interval, wherein among them, the first cleaning cloth 12 and the second cleaning cloth 13 have a shape in which a plurality of wings protrude at regular intervals along the edge.

3. The saxophone cleaning device according to claim 2, wherein:
the cleaning cloths 12, 13 and 14 enable separation and coupling with the first string 11.

4. The saxophone cleaning device according to claim 1, wherein:
the winding means 22 constituted in the pulling unit 20 uses a mainspring.

5. The saxophone cleaning device according to claim 1, wherein:
a protective layer 15a for preventing damage due to friction with the inner wall surface of the saxophone 100 is formed on the surface of the magnet 15, wherein the protective layer 15a is covered with a lattice-shaped thin film so as not to interfere with the magnetic force.

6. The saxophone cleaning device according to claim 2, wherein:
the second cleaning cloth 13 is provided with an elastic wire or elastic sponge 13 made of a material having excellent restoring force in a radial form so as to maximize the cleaning effect due to close contact with the inner wall surface of the saxophone 100.
